(19) United States
(12) Patent Application Publication
(10) Pub. No.: US 2024/0368379 A1
(43) Pub. Date: Nov. 7, 2024

(54) WEAR LAYER COMPOSITIONS

(71) Applicant: BIXBY INTERNATIONAL CORPORATAION, Newburyport, MA (US)

(72) Inventor: TIMOTHY LIBERT, Hockessin, DE (US)

(21) Appl. No.: 18/552,887

(22) PCT Filed: Mar. 18, 2022
(86) PCT No.: PCT/US22/20973

§ 371 Date: Sep. 27, 2023

Related U.S. Application Data
(60) Provisional application No. 63/167,681, filed on Mar. 30, 2021.

(51) Int. Cl. C08K 5/5419; C08J 7/04

(52) U.S. Cl. CPC C08K 5/5419; C08J 7/04; C08J 2323/06; C08J 2333/24; C08K 2201/011

(57) ABSTRACT

The present invention relates to a wear layer material composition selected from single cation or mixed cation ionomers and their blends, polyethylene with ionomer blends, polyamides with ionomer blends, acrylic blends, thermoplastic urethanes, aliphatic homo and copolymers of polyamides, co-polyesters and polycarbonates, wherein the wear layer material composition is modified with at least one additive selected from nano-silica and a siloxane additive. The wear layer is protective in nature and protects against scratches, abrasions, stains and other weatherable events.

### CROSS-REFERENCE TO RELATED APPLICATIONS

This application claims the benefit of U.S. Provisional Patent Application No. 63/167,681, filed Mar. 30, 2021, which is incorporated herein by reference.

### FIELD OF THE INVENTION

This invention relates to compositions for wear layer materials, the compositions selected from single cation ionomers or mixed cation ionomers and their blends, polyethylene with ionomer blends, polyamides with ionomer blends, acrylic blends, thermoplastic urethanes, aliphatic homo and copolymers of polyamides, copolyesters and polycarbonates, and where the compositions can be modified with at least one additive selected from nano-silica and siloxane additive.

### BACKGROUND

Wear layer or surface covering materials, including those materials adapted for use as floor and wall coverings, among other applications, have increasing demand for their scratch resistance at room temperature and or elevated temperature along with abrasion resistance or stain resistance or outdoor weatherability. Some applications may also require clarity, i.e., transparency. For some applications, the wear layer may be pigmented and/or opaque. These wear layer compositions may also be useful in materials or coverings having multiple layers with different functionalities requiring qualities such as stain, scratch, and abrasion resistance, to name a few.

JP2004017617A discloses the stain-resistant cosmetic based on silicone-modified acrylic urethane resin which is a reaction product of an acrylic polyol compound, an organopolysiloxane alkylol compound having a hydroxyl group at a terminal, and a polyisocyanate compound. Furthermore, an ultraviolet absorber and/or a light stabilizer has to be added to the stain resistant layer to provide UV resistance and the wear layer compositions. Hence these compositions are not otherwise inherently light stable, and this adds additional cost to the formulations as well as a potential concern for the leachability of those additives when in use. In addition, these compositions are not extrudable to provide desired properties and they are used as coatings only.

WO2017009066A1 discloses a decorative surface covering, in particular floor or wall covering, comprising one or more polymer layer(s) and a polyurethane top-layer completely covering the top surface of the one or more polymer layers, said top-layer comprising 40 to 75% by weight of cross-linked polyurethane. The said polyurethane comprising an anionic or cationic salt group; 0.5 to 25% by weight of one or more types of micro-scale particle(s) and/or one or more types of nano-scale particle(s) having 0.1 to 20% by weight of one or more silicone(s). These polymer compositions are cross-linked polyurethane and used as coatings and are not extrudable in nature to provide desired properties of the present invention.

U.S. Pat. No. 10,480,120B2 discloses a covering, such as a floor covering, wall covering or ceiling covering, said covering comprising a surface layer, and a substrate layer attached to said surface layer, said substrate layer optionally comprising one or more reinforced thermoplastic layers. The covering further comprises a backing layer on the bottom side of said substrate layer, opposite to said surface layer, and a textile layer attached to the bottom side of said backing layer, optionally through a contact layer. However, no mention of improved scratch resistance or abrasion resistance or stain resistance or UV resistance or clarity or extrudability as desired by the current invention's needs.

The use of radiation curable polyurethane compositions as top layer for decorative surface coverings are for example disclosed in EP 0210620B1, U.S. Pat. Nos. 4,100,318, 4,393,187, 4,598,009, 5,543,232, 6,586,108, US 2013/0230729 and WO 03/022552 but these materials are not extrudable in nature since they are crosslinked.

There is thus a need for extrudable transparent or pigmented wear layer compositions having improved scratch resistance at room temperature and/or elevated temperatures potentially combined with abrasion resistance or stain resistance or chemical resistance or outdoor weatherability including UV resistance.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The instant invention relates to a wear layer material composition selected from single cation or mixed cation ionomers and their blends, polyethylene with ionomer blends, polyamides with ionomer blends, acrylic blends, thermoplastic urethanes (TPU's), aliphatic homo and copolymers of polyamides, co-polyesters and polycarbonates, wherein the wear layer material composition is modified with at least one additive selected from nano-silica and a siloxane additive. The wear layer is protective in nature and protects against scratches, abrasions, stains and other weatherable environment.

An embodiment of the present disclosure is a composition for a wear layer material. In one embodiment, the composition includes single cation ionomers or mixed cation ionomers. In another embodiment, the composition includes polyethylene or polyamides blended with the single cation ionomers or the mixed cation ionomers. In yet another embodiment, the composition includes at least one of acrylic, thermoplastic urethanes (TPU's), aliphatic homo-polyamides or copolymers of polyamides, copolyesters and polycarbonates. In one embodiment, each of the above compositions can be modified with at least one additive selected from nano-silica or siloxane.

In some embodiments, the cation in the single cation ionomers or the mixed cation ionomers is selected from Li⁺, Na⁺, K⁺, Zn⁺² and Mg⁺². In other embodiments, the single cation ionomers or the mixed cation ionomers is derived from ethylene copolymers.

In some embodiments, the ethylene copolymers consist of from about 5% to about 20% by weight of one or more of: (i) acrylic acid or methacrylic acid co-monomers; (ii) alkyl acrylate or methacrylate ter-monomer; and (iii) at least about 10 weight % of carboxylic acid group neutralized by at least one cation, where the at least one cation is selected from Li⁺, Na⁺, K⁺, Zn⁺² and Mg⁺².

In some embodiments, the ethylene copolymers consist of from about 3% to about 25% by weight of one or more of: (i) ethylenically unsaturated dicarboxylic acid comonomer; and (ii) at least about 10 weight % of dicarboxylic acid group neutralized by at least one cation, the at least one cation is selected from Li⁺, Na⁺, K⁺, Zn⁺² and Mg⁺².

In some embodiments, the polyethylene is selected from polymers of ethylene and copolymers of ethylene and alpha-olefins having a density in the range of from about 0.900 g/cc to about 0.965 g/cc.

In some embodiments, the polyethylene can be blended with the single cation ionomers or the mixed cation ionomers consisting of from about 35 weight % to about 92 weight % of polyethylene and from about 8 weight % to about 65 weight % of the single cation ionomers or the mixed cation ionomers.

In some instances, the acrylic is selected from homopolymers of polyacrylates, homopolymers of polymethacrylates, homopolymers of polymethylmethacrylates, and blends thereof. In other instances, the acrylic is selected from copolymers of copoly (alkyl acrylates-alkyl methacrylates), copolymers of copoly (methyl acrylate methacrylates), copolymers of copoly (methyl acrylate-methyl methacrylates), copolymers of copoly (ethyl acrylate-methyl methacrylate), copolymers of copoly (methyl acrylate-methyl methacrylates), and blends thereof.

In some embodiments, the amount of the at least one additive is in the range of from about 0.5% to about 10% by weight. In some embodiments, the amount of the at least one additive is in the range of from about 1% to about 4% by weight. In some embodiments, the combination of additives of siloxane and nano-silica is in the range of from about 2% to about 6% by weight.

In an embodiment, the composition is extrudable. In some embodiments, the composition can exhibit properties including, without limitation, being (i) scratch resistant; (ii) abrasion resistant; (iii) stain resistant; or (iv) a combination of (i), (ii), or (iii).

In one embodiment, the aliphatic homo-polyamides or the copolymers of polyamides can be further blended with the single cation ionomers or the mixed cation ionomers. In some instances, the aliphatic homo-polyamides or the copolymers of polyamides can be blended with the single cation ionomers or the mixed cation ionomers consisting of from about 51 weight % to about 66 weight % of the aliphatic homo-polyamides or the copolymers of polyamides, and from about 49 weight % to about 34 weight % of the single cation ionomers or the mixed cation ionomers.

In one embodiment, the aliphatic homo-polyamides and the copolymers of polyamides further includes aliphatic homo, copolymers, and terpolymers of an aliphatic polyamide. In some instances, the aliphatic homo-polyamides and the copolymers of polyamides is selected from a group of homopolymer of aliphatic polyamide consisting of PA11 (Polyamide 11), PA12 (Polyamide 12), copolymers and terpolymers of PA 6 (Polyamide 6), copolymers and terpolymers of PA10 (Polyamide 10), copolymers and terpolymers of PA11, copolymers and terpolymers of PA12, copolymers and terpolymers of PA 6/6, copolymers and terpolymers of PA 6/6,6, copolymers and terpolymers of PA6/PA10, and copolymers and terpolymers of PA6/PA12.

In one embodiment, the at least one of acrylic and copolyesters further includes impact modifiers selected from a group consisting of acrylonitrile-butadiene-styrene (ABS), terpolymers, and methacrylate-butadiene-styrene (MBS). In these instances, the composition can exhibit properties including, without limitation, being (i) abrasion resistant; (ii) stain resistant; (iii) having reduced whitening in the presence of moisture; or (iv) a combination of (i), (ii), or (iii).

In some embodiments, the thermoplastic urethanes (TPU's) are selected from the group consisting of an aromatic polyurethane and an aliphatic polyurethane. In some instances, the aromatic polyurethane is selected from diphenyl methane diisocyanate (MDI), toluene diisocyanate (TDI) with poly (tetramethylene ether glycol) (PTMEG), poly (propylene glycol) (PPG) polyols, and blends thereof. In other instances, the aliphatic polyurethane is selected from dicyclohexamethylene diisocyanate (H12MDI), hexamethylene diisocyanate (HDI) isophorone diisocyanate (IPDI) with poly (tetramethylene ether glycol) (PTMEG), poly (propylene glycol) (PPG) polyols, and blends thereof.

In another embodiment, disclosed is a method of manufacturing a wear layer, the method includes: (a) providing a polymer composition consisting of at least one of: (i) single cation ionomers or mixed cation ionomers; (ii) polyethylene or polyamides blended with the single cation ionomers or the mixed cation ionomers; and (iii) at least one of acrylic, thermoplastic urethanes (TPU's), aliphatic homo-polyamides or copolymers of polyamides, copolyesters and polycarbonates. Next, the method includes (b) mixing the polymer composition with at least one additive selected from nano-silica or siloxane, followed by (c) extruding the wear layer with the polymer composition of step (b).

In some embodiments, the mixing step (b) includes at least one of the processes selected from the group consisting of: in-line mixing, pre-compounding, batch or continuous internal mixing process, single-screw compounding and twin-screw compounding.

These and other features and advantages will be apparent from a reading of the following detailed description. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 illustrates an exemplary extrusion sheet line.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The terms included in the instant specification to describe the invention have the general meaning as understood by one skilled in the art. Additional meanings are provided below to further describe the instant invention.

The term “wear layer” as used herein in intended to represent a top layer or outer layer that is exposed to moisture, wear and tear, can be transparent, soft, hard, and is intended to be strong, durable, provide sound insulation, improve appearance, moisture and chemical resistant, and have improved weatherability.

The terms “ionomer” and “ionomers” as used herein are intended to represent chemical entities of a class of synthetic ethylene-based thermoplastic resins consisting of a copolymer of ethylene with acid containing comonomers wherein some or all of the acid groups are neutralized by suitable cations to provide ionic cross-links. Illustrative examples of an ionomer are ethylene acrylic or methacrylic acid copolymers neutralized with metal cations or ethylene-acrylic or methacrylic acid-alkyl acrylate copolymers neutralized with metal cations. Surlyn® and Iotek® are some of the commercially available ionomers. This invention also includes other ionomer materials as mentioned by the authors Adi Eisenberg and Joon-Seop Kim in their book on Introduction to Ionomers published in 1998 (https://pubs.acs.org/doi/10.1021/ja985693m).

The terms “single cation ionomer(s)” and “mixed cation ionomer(s)” as used herein are intended to represent lithium or sodium or zinc neutralized ethylene-acrylic or methacrylic acid ionomers for single cation ionomers and blends of lithium/sodium or lithium/zinc or sodium/zinc neutralized ethylene-acrylic or methacrylic acid ionomers for mixed cation ionomers.

The term “polyethylene” as used herein is intended to represent linear low-density polyethylene (LLDPE) or low-density polyethylene (LDPE) or high-density polyethylene (HDPE). Further, polyethylene blended with single cation ionomers or mixed cation ionomers are intended to represent LLDPE or LDPE or HDPE blended with lithium or sodium or zinc neutralized ethylene-acrylic or methacrylic acid ionomers or LLDPE or LDPE or HDPE blended with lithium/sodium or lithium/zinc or sodium/zinc neutralized ethylene-acrylic or methacrylic acid ionomers.

The term “polyamide(s)” as used herein is intended to represent chemical entities of a class of polyamide(s) including homopolymers of PA11 (Polyamide 11), PA12 (Polyamide 12), copolymers and terpolymers of PA6 (Polyamide 6), copolymers and terpolymers of PA10 (Polyamide 10), copolymers and terpolymers of PA11, copolymers and terpolymers of PA12, copolymers and terpolymers of PA 6/6, copolymers and terpolymers of PA 6/6,6, copolymers and terpolymers of PA6/PA10, and copolymers and terpolymers of PA6/PA12. The present invention incorporates, by reference, thermoplastic polyamides urethanes as mentioned in the Nylon Plastics Handbook by Melvin I. Kohan published in 1995 (https://www.abebooks.com/book-search/title/nylon-plastics-handbook/%20). Also, polyamides with ionomer blends are intended to represent PA11 or PA12 or PA6 blended with zinc neutralized ethylene-acrylic or methacrylic acid ionomers.

The terms “acrylic” or “acrylic blends” as used herein are intended to include a class of acrylics as illustrated by polyacrylates, polymethylmethacrylates, copolymers of alkyl as mentioned at https://en.wikipedia.org/wiki/Acrylate_polymer and https://en.wikipedia.org/wiki/Poly(methyl_methacrylate).

The term “thermoplastic urethane(s)” as used herein is intended to represent chemical entities of a class of the aromatic or aliphatic diisocyanate with aliphatic or aromatic diols or polyols. The invention incorporates, by reference, thermoplastic polyurethanes as mentioned in the Handbook of Thermoplastic Urethanes by Michael Szycher published in 2012 (https://www.routledgehandbooks.com/doi/10.1201/b12343).

The terms “aliphatic homo-polyamides” and “copolymers of polyamides” are intended to represent chemical entities of a class of homo and copolyesters as outlined in the Handbook of Thermoplastic Polyesters: Homopolymers, Copolymers, Blends, and Composites by Fakirov (Editor) in 2002 (https://onlinelibrary.wiley.com/doi/book/10.1002/3527601961).

The term “copolyester(s)” as used herein is intended to represent a family of diacids reacting with diols such as terephthalic acid reacting with ethylene glycol to produce polyethylene terephthalate (PET). Other examples include, isophthalic acid (IPA) reacting with cyclohexane dimethanol (CHDM) to form polyethylene terephthalate (PET) based on iso form of the diacid.

The term “polycarbonates” as used herein represents chemical entities of a class of polycarbonates as outlined in the Handbook of Polycarbonate Science and Technology by editor John T. Bendler published in 1999 (https://books.google.com/books/about/Handbook_of_Polycarbonate_Science_and_Te.html?id=YL-cza_44N8C).

The term “additive” as used herein is intended to represent a family of materials added to another substance or product to produce specific properties in the combined substance or final products. For example, the addition of nano-silica or siloxane to ionomers of the present invention enhances shear resistant or abrasion resistant or a combination of both.

The terms “nano-silica” and “siloxane” as used herein are independently intended to represent chemical entities of a class of silicone or siloxane-based material as outlined in the Handbook of Silicon Based MEMS Materials and Technologies (Micro and Nano Technologies) 3rd Edition by Markku Tilli et al. (Editor) published 2020 (https://www.sciencedirect.com/book/9780815515944/handbook-of-silicon-based-mems-materials-and-technologies). In addition, the foregoing terms represent certain amount of additives including nano-silica and siloxane that are dispersed in one or more carrier resins that are compatible with matrix polymers for the wear layer compositions.

An “extrudable” composition or “extruding” a wear layer with a polymer composition is meant to represent a composition that is manufactured by an extrusion process known to one skilled in the art. Further, an extrudable composition represents a family of homo and copolymers that possess required melt viscosity so that those polymers are extrudable in nature.

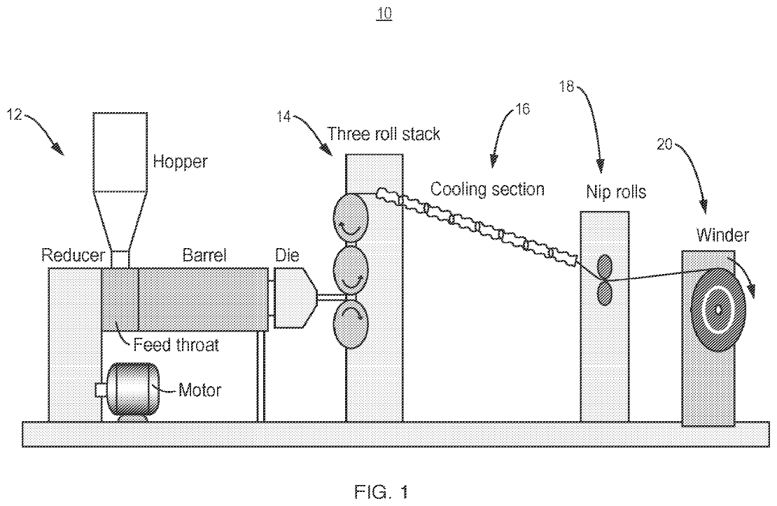

FIG. 1 illustrates an exemplary extrusion process. As shown, an exemplary sheet line 10 includes an extruder 12, a roll stack 14, a cooling section 16, a nip/pull roll section 18 and a winder 20. In this example, the roll stack 14 contains three rolls that are often referred to as polishing rolls. They are used to exert pressure on a sheet and to impart surface conditions of the rolls to the plastic sheet. If a smooth surface is required, smooth rolls are used. If a textured surface is needed, a textured surface is used on the roll. The roll texture is the negative of the texture required on the sheet. It is possible to produce a sheet with one textured surface and the other smooth by using a smooth and a textured roll next to each other.

As used herein, “acrylic acid” and “methacrylic acid co-monomers” represent a class of acid comonomers. Illustrative examples are acrylic acid and methacrylic acid.

As used herein, “alkyl acrylate” and “methacrylate ter-monomer” represent a class of third monomer to produce copolymers having three monomers together like in the case of copolymer of ethylene with acrylic or methacrylic acid and methyl acrylate or butyl acrylate. Illustrative examples include methyl acrylate or butyl acrylate.

As used herein, a carboxylic acid group neutralized by at least one cation or a metal cation is intended to represent a carboxylic acid (COOH) group which is neutralized by a metal base to form a (COO⁻ M⁺) moiety wherein M⁺ represents a metal cation. Illustrative examples of metal bases are lithium hydroxide, sodium hydroxide and zinc oxide, while illustrative examples of at least one cation or a metal cation are Li⁺, Na⁺, K⁺, Zn⁺² and Mg⁺².

The terms “scratch resistant” and “abrasion resistant” are intended to describe the ability of a material/surface to resist various types of damage such as scratches, gouges, wears and other flaws. This parameter is crucial in the coating industry since the degree of scratch and abrasion resistance in coatings or wear layers can govern the longevity of the product and also determine its ability to protect the coated material against corrosion.

The term “stain resistant” as used herein is intended to describe the property of a fabric, layer, surface, or the like to resist penetration of a liquid stain substance while possibly allowing the passage of air and moisture. The finish can be a wax emulsion or other chemical, and each option varies in efficacy, toxicity and eco-friendliness. Stain resistance includes the ability to withstand permanent discoloration by the action of liquids. This property depends partly upon the chemical nature of the fiber but may be improved by proprietary treatments.

### Materials

TABLE 1 is a listing of materials that may be used in manufacturing the presently disclosed compositions as can be appreciated by one skilled in the art.

TABLE 1
Materials that may be used in the compositions.

Ionomers: Surlyn ™ 1601, 1650, 9910, 8150, and blends thereof
Acrylics: Plaskolite ™ CA 1000 E-2, SolarKote ™ a200 and a207, and blends thereof
Thermoplastic Urethane (TPU): Texin ™ 8980D, 8955DE, 8990A, and blends thereof
Long Chain Polyamide (LCPA): BESNO PA11, Vestamid ™ LX 9036, Terpalex ™
6434, Ubesta 303XA, and blends thereof
Polyesters and copolyesters: Eastar ™ 6763 PETg and Tritan ™ FX100
Polyamide: Zytel ® 101L NC010, Ultramid ® B3S R03 and UBE Nylon 5024B
Polyethylene: High-density polyethylene (HDPE)
Polycarbonates: Lexan ™ grade
Masterbatches (nano-silica):
50% nano-silica masterbatch in Na and Zn ionomer carrier resins
50% nano-silica in PMMA carrier resin
Masterbatches (siloxane):
Multibase ™ HMB-1103 (50% masterbatch in EMA carrier)
Multibase ™ MB50-017 (50% masterbatch in TPU carrier)

In some embodiments, the methods of manufacturing the compositions include mixing with processes such as in-line mixing, pre-compounding, batch or continuous internal mixing process, single-screw compounding and twin-screw compounding. The compositions can also be manufactured according to other processes as can be appreciated by one skilled in the art.

In one embodiment, the method includes providing polymer compositions having single cation ionomers or mixed cation ionomers, the ionomers being those shown in TABLE 1. In another embodiment, the polymer compositions can be polyethylene or polyamides blended with the single cation ionomers or the mixed cation ionomers similar to those shown above. In yet other embodiments, the polymer compositions can be prepared by providing at least one of acrylic, thermoplastic urethanes (TPU's), aliphatic homo-polyamides or copolymers of polyamides, copolyesters and polycarbonates, among others.

In the next step of the manufacturing process, the polymer composition can be mixed with at least one additive. In one embodiment, the additive can be nano-silica. In another embodiment, the additive can be siloxane. In yet another embodiment, the additive can be a combination of nano-silica and siloxane. Example additives of nano-silica and/or siloxane can be similar to those shown in TABLE 1. The wear layer material may subsequently be produced by extruding with the polymer compositions using at least one of the above methods.

The polymer compositions for an extrudable wear layer material can be single cation ionomers and their blends, mixed cation ionomers and their blends, acrylics and their blends, thermoplastic urethanes (TPU's) and their blends, polyethylene with ionomer blends, polyamides with ionomer blends, aliphatic homo and copolymers of polyamides and their blends, copolyesters and their blends and polycarbonates and their blends using the materials shown in TABLE 1. In addition, the polymer compositions can be modified with at least one additive selected from nano-silica and siloxane additives shown in TABLE 1.

In one embodiment, the combination of additives of siloxane and nano-silica can be in the range of from about 0.5% to about 10% by weight of the total composition. In some embodiments, the combination of additives of siloxane and nano-silica can be in the range of from about 1% to about 5% by weight, or from about 2% to about 6% by weight, or from about 1% to about 4% by weight, of the total composition. In another embodiment, the combination of additives of siloxane and nano-silica can be in the range of from about 1% to about 2% by weight of the total composition.

In some embodiments, the single additive can be siloxane and be in the range of from about 1% to about 4% by weight or from about 1% to about 2% by weight, of the total composition. In some embodiments, the single additive can be siloxane and be in the range of from about 0.5% to about 10% by weight, or from about 1% to about 5% by weight, or from about 2% to about 6% by weight, of the total composition.

In some embodiments, the single additive can be nano-silica and be in the range of from about 1% to about 4% by weight or from about 1% to about 2% by weight, of the total composition. In some embodiments, the single additive can be nano-silica and be in the range of from about 0.5% to about 10% by weight, or from about 1% to about 5% by weight, or from about 2% to about 6% by weight, of the total composition.

In some embodiments, the following polymers, among others, may be impact modified at times: acrylics, polyamides and copolyesters. Ionomers, ionomer alloys with polyethylene or nylon, and thermoplastic urethanes are typically not impact modified as they are intrinsically resistant to impact. Accordingly, in some embodiments, polymer compositions having at least one of acrylic and copolyesters may be impacted with impact modifiers selected from the group consisting of acrylonitrile-butadiene-styrene (ABS), terpolymers, and methacrylate-butadiene-styrene (MBS).

### Methods

The following ASTM procedures were used for determining the properties of the polymer compositions according to the present disclosure.

5-Finger Scratch Testing (ASTM D7027-20; ISO 19252)—Carriage speed at 100 mm/sec. scratch tip at 0.1 mm conical tip, stylus weights were generally 7N, 10N, 15N, 20N and 25N. For less scratch resistant samples, replace 25N weight with 5N weight (stylus weights were then 5N, 7N, 10N, 15N and 20N). Visual rating was given for each stylus weight (“1”=no evidence of scratch; “3”=could definitely see scratch line; 5=sample torn or cut). Record max weight with rating of “1”, min weight with rating of “3” and min weight with rating of “5.”

Taber Abrasion (ASTM D3884)-(1) cut 4″×4″ square sample, (2) select which abrasion wheel (e.g., roughness, weight) to use for testing (CS10, CS17, H18), (3) take photo and measure/record initial thickness prior to abrasion, (4) stamp hole from middle of sample to mount in abrasion tester and measure/record initial weight of sample after hole punch out, (5) place/mount sample in tester and place abrasion wheel on top of sample, (6) start “sheet test cycle,” (7) reset process after 500 cycles, (8) measure/record thickness where abrasion wheel contact sample and (9) measure/record sample weight after testing. Repeat steps (5) to (9) until 2000 cycles.

Stain Resistance (ASTM 2299-69)—Cut 1″ wide sample out of film/sheet, measure “baseline/control” b-value (D65) (e.g., color scale) of sample (prior to exposure to stain) using Konica Minolta spectrophotometer, define length of time to expose sample to stain and temperature in oven and staining materials, expose samples to stain for at least 24 hours in 100° F. oven with mustard, coffee, ketchup and red wine as staining materials, after exposure to stain at above time and temperature, remove samples from stain and wipe staining materials from 1″ sample strips and allow to dry. Measure b-value (D65) using Konica Minolta spectrophotometer after exposure to stain and measure change from control/baseline value.

### Results

TABLE 2 lists the test results of the presently disclosed compositions.

TABLE 2
Test results of presently disclosed compositions.

| | | | | Stain |
|---|---|---|---|---|
| | | | | Resistance |
| | 5-Finger | Taber CS10 | Taber CS17 | for mustard |
| Wear Layer/Additive(s) | Scratch | @ 1000 gm | @ 500 gm | (“b-value”) |
| 80D TPU | — | reference | reference | — |
| 80D TPU + siloxane | — | better | better | — |
| 55D TPU | reference | — | — | — |
| 55D TPU + siloxane | better | — | — | — |
| Ionomer blend | reference | reference | reference | — |
| Ionomer blend + nano-silica | better | better | better | better |
| Ionomer blend + siloxane | better | better | better | better |
| Ionomer blend + nano-silica + siloxane | better | better | better | better |
| Acrylic | reference | reference | reference | reference |
| Acrylic + nano-silica | better | better | better | — |
| Acrylic + siloxane | better | better | better | better |
| Acrylic + nano-silica + siloxane | better | better | better | — |

As summarized in TABLE 2 above, the following benefits, among others, were observed. For example, addition of siloxane improved scratch resistance and abrasion resistance of aliphatic thermoplastic urethane wear layer compositions. Furthermore, addition of nano-silica and/or siloxane, separately or in combination, improved scratch resistance, abrasion resistance and stain resistance, of ionomer (e.g., single cation ionomers, mixed cation ionomers, and ionomer blends) wear layer compositions. Similarly, addition of nano-silica and/or siloxane, separately or in combination, improved scratch resistance and abrasion resistance of acrylic wear layers compositions. And addition of siloxane has shown improved stain resistance of acrylic wear layers compositions.

While example embodiments have been particularly shown and described, it will be understood by those skilled in the art that various changes in form and details may be made therein without departing from the scope of the embodiments encompassed by the appended claims. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A composition for a wear layer material, wherein the composition comprising:
(a) single cation ionomers or mixed cation ionomers; or
(b) polyethylene or polyamides blended with the single cation ionomers or the mixed cation ionomers; or
(c) at least one of acrylic, thermoplastic urethanes, aliphatic homo-polyamides or copolymers of polyamides, copolyesters and polycarbonates; and
(d) modified with at least one additive selected from nano-silica or siloxane.

2. The composition of claim 1, wherein the cation in the single cation ionomers or the mixed cation ionomers is selected from Li⁺, Na⁺, K⁺, Zn⁺² and Mg⁺².

3. The composition of claim 1, wherein the single cation ionomers or the mixed cation ionomers is derived from ethylene copolymers.

4. The composition of claim 3, wherein the ethylene copolymers consist of from about 5% to about 20% by weight of one or more of:
(i) acrylic acid or methacrylic acid co-monomers;
(ii) alkyl acrylate or methacrylate ter-monomer; and
(iii) at least about 10 weight % of carboxylic acid group neutralized by at least one cation, the at least one cation is selected from Li⁺, Na⁺, K⁺, Zn⁺² and Mg⁺².

5. The composition of claim 3, wherein the ethylene copolymers consist of from about 3% to about 25% by weight of one or more of:
(i) ethylenically unsaturated dicarboxylic acid comonomer; and
(ii) at least about 10 weight % of dicarboxylic acid group neutralized by at least one cation, the at least one cation is selected from Li⁺, Na⁺, K⁺, Zn⁺² and Mg⁺².

6. The composition of claim 1, wherein the polyethylene is selected from polymers of ethylene and copolymers of ethylene and alpha-olefins having a density in the range of from about 0.900 g/cc to about 0.965 g/cc.

7. The composition of claim 1, wherein the polyethylene blended with the single cation ionomers or the mixed cation ionomers consisting of from about 35 weight % to about 92 weight % of polyethylene and from about 8 weight % to about 65 weight % of the single cation ionomers or the mixed cation ionomers.

8. The composition of claim 1, wherein the acrylic is selected from homopolymers of polyacrylates, homopolymers of polymethacrylates, homopolymers of polymethylmethacrylates, and blends thereof.

9. The composition of claim 1, wherein the acrylic is selected from copolymers of copoly (alkyl acrylates-alkyl methacrylates), copolymers of copoly (methyl acrylate methacrylates), copolymers of copoly (methyl acrylate-methyl methacrylates), copolymers of copoly (ethyl acrylate-methyl methacrylate), copolymers of copoly (methyl acrylate-methyl methacrylates), and blends thereof.

10. The composition of claim 1, wherein the amount of the at least one additive is in the range of from about 0.5% to about 10% by weight.

11. The composition of claim 1, wherein the amount of the at least one additive is in the range of from about 1% to about 4% by weight.

12. The composition of claim 1, wherein the combination of additives of siloxane and nano-silica is in the range of from about 2% to about 6% by weight.

13. The composition of claim 1, wherein the composition is extrudable.

14. The composition of claim 1, wherein the composition is:
(i) scratch resistant;
(ii) abrasion resistant;
(iii) stain resistant; or
(iv) a combination of (i), (ii), or (iii).

15. The composition of claim 1, wherein the aliphatic homo-polyamides or the copolymers of polyamides is further blended with the single cation ionomers or the mixed cation ionomers.

16. The composition of claim 15, wherein the aliphatic homo-polyamides or the copolymers of polyamides blended with the single cation ionomers or the mixed cation ionomers consisting of from about 51 weight % to about 66 weight % of the aliphatic homo-polyamides or the copolymers of polyamides, and from about 49 weight % to about 34 weight % of the single cation ionomers or the mixed cation ionomers.

17. The composition of claim 1, wherein the aliphatic homo-polyamides and the copolymers of polyamides further includes aliphatic homo, copolymers, and terpolymers of an aliphatic amide.

18. The composition of claim 17, wherein the aliphatic homo-polyamides and the copolymers of polyamides is selected from a group of homopolymer of aliphatic polyamide consisting of PA11 (Polyamide 11), PA12 (Polyamide 12), copolymers and terpolymers of PA 6 (Polyamide 6), copolymers and terpolymers of PA10 (Polyamide 10), copolymers and terpolymers of PA11, copolymers and terpolymers of PA12, copolymers and terpolymers of PA 6/6, copolymers and terpolymers of PA 6/6,6, copolymers and terpolymers of PA6/PA10, and copolymers and terpolymers of PA6/PA12.

19. The composition of claim 1, wherein the at least one of acrylic and copolyesters further comprises impact modifiers selected from a group consisting of acrylonitrile-butadiene-styrene (ABS), terpolymers, and methacrylate-butadiene-styrene (MBS).

20. The composition of claim 19, wherein the composition is:
(i) abrasion resistant;
(ii) stain resistant;
(iii) has reduced whitening in the presence of moisture; or
(iv) a combination of (i), (ii), or (iii).

21. The composition of claim 1, wherein the thermoplastic urethanes are selected from the group consisting of an aromatic polyurethane and an aliphatic polyurethane.

22. The composition of claim 21, wherein the aromatic polyurethane is selected from diphenyl methane diisocyanate (MDI), toluene diisocyanate (TDI) with poly (tetramethylene ether glycol) (PTMEG), poly (propylene glycol) (PPG) polyols, and blends thereof.

23. The composition of claim 21, wherein the aliphatic polyurethane is selected from dicyclohexamethylene diisocyanate (H12MDI), hexamethylene diisocyanate (HDI) isophorone diisocyanate (IPDI) with poly (tetramethylene ether glycol) (PTMEG), poly (propylene glycol) (PPG) polyols, and blends thereof.

24. A method of manufacturing a wear layer, the method comprising:
(a) providing a polymer composition consisting of at least one of:
(i) single cation ionomers or mixed cation ionomers;
(ii) polyethylene or polyamides blended with the single cation ionomers or the mixed cation ionomers; and
(iii) at least one of acrylic, thermoplastic urethanes, aliphatic homo-polyamides or copolymers of polyamides, copolyesters and polycarbonates;
(b) mixing the polymer composition with at least one additive selected from nano-silica or siloxane; and
(c) extruding the wear layer with the polymer composition of step (b).

25. The method of claim 24, wherein the mixing step (b) includes at least one of the processes selected from the group consisting of: in-line mixing, pre-compounding, batch or continuous internal mixing process, single-screw compounding and twin-screw compounding.
